(19) United States
(12) Patent Application Publication
(10) Pub. No.: US 2020/0261886 A1
(43) Pub. Date: Aug. 20, 2020

(54) FILTER AND FLUID SEPARATION METHOD

(71) Applicant: TORAY INDUSTRIES, INC., Tokyo (JP)

(72) Inventors: Ryoma MIYAMOTO, Shiga (JP); Gohei YAMAMURA, Shiga (JP); Yoichiro KOZAKI, Shiga (JP); Ryuichiro HIRANABE, Shiga (JP); Satoko KANAMORI, Shiga (JP)

(73) Assignee: TORAY INDUSTRIES, INC., Tokyo (JP)

(21) Appl. No.: 16/651,507

(22) PCT Filed: Aug. 31, 2018
(86) PCT No.: PCT/JP2018/032492

§ 371 Date: Mar. 27, 2020

(30) Foreign Application Priority Data
Sep. 29, 2017 (JP) 2017-189898

(51) Int. Cl. B01J 20/28; B01J 20/02

(52) U.S. Cl. CPC B01J 20/28004; B01J 20/28057; B01J 20/28028; B01J 20/0229; B01J 20/0211; B01J 20/0237

(57) ABSTRACT

Provided is a filter having either or both of a winding and a laminate that include a fiber-like absorbing material, wherein the fiber-like absorbing material has a base material and metal particles supported on the base material, and the diameter D of the fiber-like absorbing material, the void fraction of the winding or laminate, and the variation in the area void fraction in the radial direction of the winding or the variation in the area void fraction in the direction of lamination are in a specific range.

### TECHNICAL FIELD

The present invention relates to an adsorbent material suitable for removing substances contained in a fluid such as water and gas, and a fluid separation method using the adsorbent material.

### BACKGROUND ART

In recent years, there is an increasing demand for removing hazardous substances contained in a fluid such as water and gas. In the field of water treatment, examples of hazardous substances that should be removed include arsenic contained in groundwater, phosphorus and fluorine contained in wastewater, boron contained in seawater, and the like. Methods for removing these hazardous substances including removal or inactivation by an adsorbent material has been studied.

Patent Literature 1 discloses an arsenic-trapping fiber. The arsenic-trapping fiber is produced by: allowing a fiber base material to react with a cross-linking reactive compound having both reactive double bonds and glycidyl groups in the presence of a redox catalyst, thereby performing grafting of groups having the glycidyl group to molecules of the fiber base material like a pendant; and next, allowing the graft adduct to react with a chelate-forming compound having a functional group reactive with the glycidyl groups, thereby introducing chelate-forming functional groups into the fiber base material.

Patent Literature 2 discloses a zirconium-supported fibrous adsorbent material obtained by graft-polymerizing a reactive monomer having a phosphate group with a base material, and immersing the polymer in a solution of a zirconium compound.

### CITATION LIST

### Patent Literature

Patent Literature 1: JP-A-2004-68182
Patent Literature 2: JP-A-2004-188307

### SUMMARY OF INVENTION

### Technical Problem

The adsorbent materials described in Patent Literatures 1 and 2 have disadvantages that an adsorption rate thereof is slow and adsorption performances under a high flow rate are not sufficient.

In view of the background of the related art, the present invention provides an adsorbent material having small permeation resistance and excellent adsorption performances even under a high flow rate in the removal of hazardous substances contained in a fluid such as water and gas.

### Solution to Problem

A filter according to the present invention including: at least one of a winding body containing a fibrous adsorbent material and a laminated body containing the fibrous adsorbent material, in which
(a) the fibrous adsorbent material is capable of adsorbing a component dissolved in a liquid,
(b) the fibrous adsorbent material includes a base material and metal particles supported by the base material,
(c) the fibrous adsorbent material has a diameter D of 100 μm or more and 600 μm or less,
(d) the metal particle has a particle diameter of 1 nm or more and 1000 nm or less,
(e) the metal particles are supported by the base material in at least one form selected from the following (1) to (3):
   (1) the metal particles are bonded to the base material via functional groups;
   (2) the base material has holes, and the metal particles are supported in the holes; and
   (3) a coating layer containing the metal particles and a polymer is provided on a surface of the base material,
(f) the winding body and the laminated body have porosity of 15% or more and 70% or less, and
(g) variation in area porosity of the winding body in a radial direction of a winding and variation in area porosity of the laminated body in a lamination direction are 15% or less.

The base material is preferably a monofilament or a multifilament containing a plurality of monofilaments.

The metal particles are preferably particles containing at least one kind selected from the group consisting of silver, copper, iron, titanium, zirconium, and cerium.

The fibrous adsorbent material preferably contains the metal particles in a proportion of 10 parts by mass or more per 100 parts by mass of the fibrous adsorbent materials.

It is preferred that the metal particles are supported by the base material in the form of (3), and that the fibrous adsorbent material contains 30 to 400 parts by mass of the coating layers per 100 parts by mass of the base materials.

The present invention also provides a fluid separation method utilizing the above filter.

The fluid separation method according to the present invention includes: (a) a step of separating a substance contained in a fluid from the fluid by a separation membrane; and (b) a step of bringing the fluid into contact with the filter according to the present invention, in which the step (b) is performed before or after the step (a).

### Advantageous Effects of Invention

According to the present invention, since the diameter D of the fibrous adsorbent material is 100 μm or more, the water flow resistance decreases. When the diameter D is 600 μm or less, the adsorption rate can be increased. When the porosity of the winding body and the laminated body is 15% or more, clogging is less likely to occur during water flow, and the water flow resistance is less likely to increase. When the porosity is 70% or less, components to be removed in the raw water can be suitably removed without causing short pass of raw water when the raw water flows through the filter. When the variation in area porosity in a radical direction of a winding of the winding body or variation in area porosity in a lamination direction of the laminated body is 15% or less, vortex is less likely to occur during water flow, and the water flow resistance can be reduced. The fibrous adsorbent material according to the present invention can be preferably used for applications that require high adsorption performances even at a high flow rate.

Specifically, the fibrous adsorbent material can be preferably used for removal of hazardous substances contained in a fluid such as water and gas, particularly removal of arsenic contained in groundwater, phosphorus and fluorine contained in wastewater, and boron contained in seawater.

### BRIEF DESCRIPTION OF DRAWINGS

FIG. 1 is a cross-sectional view showing an example of a monofilament as a base material.

FIG. 2 is a cross-sectional view showing an example of a fibrous adsorbent material, and in the fibrous adsorbent material of the present example, metal particles are bonded to functional groups of the base material.

FIG. 3 is a cross-sectional view showing an example of a fibrous adsorbent material, and in the fibrous adsorbent material of the present example, metal particles are bonded to insides of the holes present in a surface of the base material.

FIG. 4 is a cross-sectional view showing an example of a fibrous adsorbent material, and in the fibrous adsorbent material of the present example, a coating layer containing metal particles is formed around a monofilament as a base material.

FIG. 5 is a cross-sectional view showing an example of a fibrous adsorbent material, and in the fibrous adsorbent material of the present example, a coating layer containing metal particles formed around monofilaments contained in a multifilament as a base material.

FIG. 6 is a schematic view showing an example of a filter including a winding body.

FIG. 7 is a schematic view showing an example of a filter including a laminated body.

### DESCRIPTION OF EMBODIMENTS

Hereinafter, embodiments of the present invention will be described in detail.

In the present description, the term “mass” has the same meaning as the term “weight”.

[A. Fibrous Adsorbent Material]

A fibrous adsorbent material according to an embodiment of the present invention will be described below. Hereinafter, the fibrous adsorbent material is sometimes simply referred to as “adsorbent material”. In the present embodiment, the adsorbent material includes a base material and metal particles supported by the base material. When the adsorbent material includes the metal particles, components dissolved in a liquid, specifically, hazardous substances contained in a fluid such as water and gas, for example, arsenic, phosphorus, fluorine, and boron, can be adsorbed.

(A-1) Base Material

(A-1-1) Constituent Material

In the present embodiment, the expression “X contains Y as a main component” means that the content of Y in X is 50 mass % or more, preferably 70 mass % or more, more preferably 90 mass % or more, and most preferably 100 mass %.

The material constituting the base material is not particularly limited, and the base material may contain, for example, polyolefins, halogenated polyolefins, polyacrylonitriles, polyvinyl compounds, polycarbonates, poly (meth)acrylates, polysulfones, polyethersulfones, polyamides, polyesters, and cellulose esters, as a main component.

Specific examples of the polyolefins include polyethylene, polypropylene, and the like.

Specific examples of the halogenated polyolefins include polyvinyl chloride, polytetrafluoroethylene (PTFE), polyvinylidene fluoride, and the like.

Specific examples of the polyamides include nylon 6, nylon 66, nylon 11, nylon 12, and the like.

Specific examples of the polyesters include aromatic polyesters composed of aromatic dicarboxylic acid moieties and glycol moieties, aliphatic polyesters composed of aliphatic dicarboxylic acids and glycol moieties, polyesters composed of hydroxycarboxylic acids, and copolymers thereof, and the like.

Specific examples of the aromatic dicarboxylic acids include terephthalic acid, isophthalic acid, naphthalene dicarboxylic acid, and the like. Specific examples of the glycols include ethylene glycol, 1,2-propylene glycol, 1,3-propylene glycol, 1,2-butanediol, 1,3-butanediol, 1,4-butanediol, and the like.

Specific examples of the hydroxycarboxylic acids include glycolic acid, lactic acid, hydroxypropionic acid, hydroxybutyric acid, hydroxyvaleric acid, hydroxycaproic acid, hydroxybenzoic acid, and the like.

In addition, the polyesters may be copolymerized to the extent that characteristics thereof are not changed greatly. Examples of the copolymerization component include 5-(alkali metal) sulfoisophthalic acid, such as 5-sodium sulfoisophthalic acid, polycarboxylic acids other than the aromatic dicarboxylic acids described above, and the like.

Specific examples of the cellulose esters include cellulose acetate, cellulose propionate, cellulose butyrate, mixed cellulose esters obtained by blocking three hydroxyl groups present in a glucose unit of cellulose by two or more kinds of acyl groups, and derivatives thereof.

These materials may be used in combination of two or more kinds thereof. In this case, the total content of these materials in the base material may be equal to or more than a lower limit of a proportion of the “main component”. For example, when the base material contains polysulfones and cellulose esters, even though each of the content of the polysulfones and the content of the cellulose esters is less than 50 mass %, and the total content thereof have only to be 50 mass % or more based on the base material.

The base material may further contain additives in addition to those exemplified above. Here, examples of the additives include other polymers, plasticizers, oxidation preventing agents, organic lubricants, crystal nucleating agents, organic particles, inorganic particles, terminal-blocking agents, chain extenders, ultraviolet absorbers, infrared ray absorbers, anti-coloring agents, matting agents, antibacterial agents, charge control agents, deodorants, flame retardants, weathering agents, antistatic agents, antioxidants, ion exchangers, and antifoaming agents, coloring pigments, fluorescent whitening agents, dyes, and the like.

(A-1-2) Shape

The base material is preferably fibrous. The fibrous form refers to a shape long in one direction. The base material preferably has a diameter of 10 μm or more and 500 μm or less. A length of the base material may be selected based on a shape of a target adsorbent material.

In a case where the base material is fibrous, the base material is preferably a monofilament or a multifilament containing a plurality of monofilaments. In a case where the base material is a multifilament, the metal particles are held between the monofilaments, that is, in the base material. Accordingly, an adsorbent material having an excellent adsorption performance is obtained.

A cross-sectional shape of the monofilament contained in the base material is not particularly limited, and may be circular. However, the base material preferably contains a monofilament with an irregular cross section.

The irregular cross section refers to a cross-sectional shape other than circle. Examples of the irregular cross section may include: polygon (preferably triangle, square, pentagon, and hexagon); a flat shape; a lens type; a shape called multilobar shape such as trilobal and sexfoil, which is formed by alternately arranging a plurality of (preferably 3 to 8) projected parts and the same number of recessed parts; and the like.

The monofilament with an irregular cross section has a large specific surface area. In addition, when the base material is a multifilament containing a plurality of monofilaments having an irregular cross section, a gap between the monofilaments is larger than that in the case where the base material includes only monofilaments having a circular cross section. As described above, since the base material includes monofilaments having an irregular cross section, the adsorbent material including the base material can hold a large number of metal particles regardless of the base material being a monofilament or a multifilament. As a result, an adsorbent material having an excellent adsorption performance is obtained.

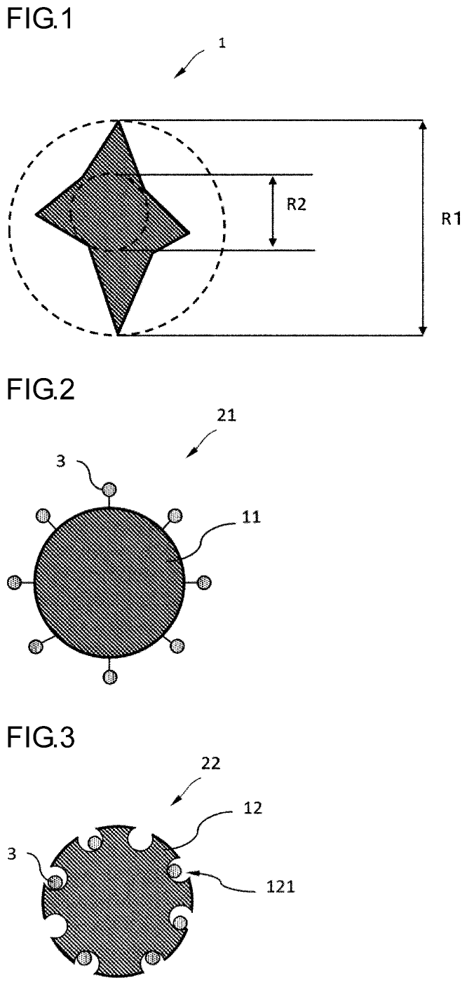

The degree of irregularity of the cross section is preferably 1.2 or more and 6.0 or less. The degree of irregularity is a value (R1/R2) obtained by dividing a diameter R1 of the smallest circle encompassing the cross section of a monofilament 1 by a diameter R2 of the largest circle that fits in the cross section of the monofilament 1 (see FIG. 1).

A specific surface area of the monofilament becomes relatively large when the degree of irregularity is 1.2 or more, so that a large number of metal particles can be held on the surface of the monofilament. On the other hand, when the degree of irregularity is 6.0 or less, there is an advantage that yarn breakage is less likely to occur.

(A-1-3) Surface of Base Material

Depending on a support form of the metal particles by the base material, the surface of the base material should have functional groups that interact with the metal particles.

A treatment method for imparting such functional groups to the surface of the base material is not particularly limited, and examples thereof include photochemical treatment such as corona discharge treatment, plasma treatment, alkali treatment, electron beam radiation treatment, and vacuum ultraviolet treatment, and chemical treatment such as sulfonation, amination, carboxylation, and nitration.

Corona discharge treatment, for example, plasma treatment, is preferably performed in an atmosphere of a specific gas because of good efficiency in inducing functional groups. Examples of the kinds of gas include oxygen gas, nitrogen gas, carbon dioxide gas, and a mixed gas thereof. The treatment intensity at that time can be set optionally. The chemical treatment method is not particularly limited, and examples thereof include sulfonation using sulfuric acid, amination using ammonia, and carboxylation using carbon dioxide.

(A-2) Metal Particles

(A-2-1) Composition

The metal constituting the metal particles can be optionally selected depending on an adsorption object. For example, the metal particles may be at least one kind of metal selected from the group consisting of silver, copper, iron, titanium, zirconium, and cerium.

For example, when the adsorption object is boron ions, arsenic ions, phosphorus ions, and fluorine ions, examples of the metal particles include metal oxides, metal hydroxides and hydrates thereof.

In addition, as the particulate metal particles, metal hydroxides and metal hydrous oxide are preferred from the viewpoint of adsorption capacity.

Examples of the metal hydroxides and the metal hydrous oxide include rare earth element hydroxides, rare earth element hydrous oxide, zirconium hydroxide, zirconium hydrous oxide, ferric hydroxide, and hydrous ferric oxide. Examples of the rare earth element include scandium Sc having an atomic number of 21, yttrium Y having an atomic number of 39, and lanthanoid elements from the atomic number of 57 to the atomic number of 71, that is, lanthanum La, cerium Ce, praseodymium Pr, neodymium Nd, promethium Pm, samarium Sm, europium Eu, cadolinium Gd, terbium Tb, dysprosium Dy, holmium Ho, erbium Er, thulium Tm, ytterbium Yb and lutetium Lu, which are based on the periodic table of elements. Among them, cerium is a preferred element, and tetravalent cerium is more preferred, from the viewpoint of ion removal performances. Mixtures of these hydroxides and/or hydrous oxide are also useful.

The moisture content of the metal particles is preferably 1 mass % or more, and more preferably 5 mass % or more. When the moisture content is 1% by mass or more, the inside of the particles can have adsorption sites, and the metal particles exhibit sufficient adsorption capacity. The moisture content is preferably 30 mass % or less, and more preferably 20 mass % or less. When the moisture content is 30 mass % or less, the density of the adsorption sites inside the particles can be increased, and the metal particles exhibit sufficient adsorption capacity.

(A-2-2) Particle Diameter

The particle diameter of the metal particles is 1 nm or more and 1000 nm or less. The particle diameter refers to a particle diameter of particles in dispersed state (primary particles) when the particles are dispersed, and refers to a particle diameter of particles in aggregated state (secondary particles) when the particles are aggregated.

The particle diameter of the metal particles is preferably 500 nm or less, more preferably 100 nm or less, and still more preferably 50 nm or less. When the particle diameter is more than 1000 nm, the number of adsorption sites present on outer surfaces of the particles is reduced, and the particles cannot exhibit sufficient adsorption capacity. The particle diameter of the metal particles is preferably 5 nm or more, more preferably 10 nm or more, and still more preferably 15 nm or more. Considering the aggregation of particles during manufacturing of the adsorbent material, a lower limit of the particle diameter is 1 nm.

(A-2-3) Support Form on Base Material

In the adsorbent material according to the present invention, the support form of the metal particles on the base material is at least one selected from the following (1) to (3).

(1) Metal particles are bonded to the base material via functional groups.

(2) The base material has holes, and the metal particles are supported in the holes of the base material.

(3) A coating layer containing the metal particles and a polymer is provided on the surface of the base material.

The respective forms will be described with reference to FIGS. 2 to 5, respectively. Although the cross section of the base material is depicted as a circle in the drawings for convenience of description, various shapes can be applied to the base material as described above.

(A-2-3-1) A Case where Metal Particles are Bonded to Base Material Via Functional Groups

In the adsorbent material 21 shown in FIG. 2, metal particles 3 are bonded to a base material 11 via functional groups. More specifically, the metal particles 3 are bonded to a surface of the base material 11 via the functional groups contained by compounds constituting the base material 11.

The kind of bonding of the metal particles to the base material is not particularly limited, and examples thereof include bonding caused by covalent bonds, ionic bonds, coordination bonds, metal bonds, hydrogen bonds, and bonds by van der Waals force.

The kind of the functional groups is not particularly limited, and examples thereof include amino groups, carbonyl groups, carboxyl groups, hydroxyl groups, aldehyde groups, sulfo groups, nitro groups, thiol groups, ether bonds, ester bonds, amide bonds, imide bonds, sulfide bonds, fluoro groups, chloro groups, bromo groups, iodo groups, astato groups, and the like. In addition, these functional groups may be charged.

(A-2-3-2) A Case where Metal Particles are Supported in Holes of Base Material

In a case where the metal particles are supported in the holes of the base material, the form of the support is not particularly limited, and a form in which the base material is a membrane having holes on its surface and metal particles are placed in the holes is exemplified. FIG. 3 shows an adsorbent material 22 including a base material 12 having holes 121 on a surface thereof and the metal particles 3 supported in the holes.

The holes may be an independent hole or a through hole. In addition, the base material may also have a hole inside thereof. The metal particles may be bonded to functional groups present in the holes of the base material. The bonding mode of the metal particles to the base material and the functional groups are described as above.

(A-2-3-3) A Case where Coating Layer Containing Metal Particles and Polymer is Provided on Surface of Base Material

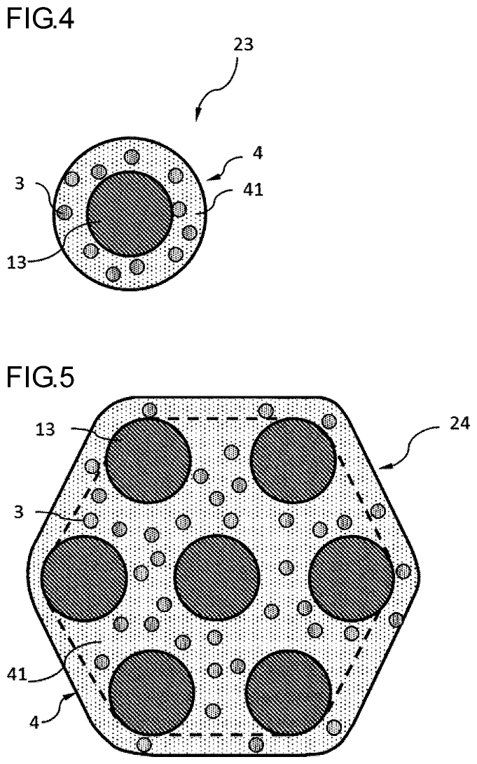

As an example in which the coating layer containing the metal particles and the polymer is provided on the surface of the base material, an adsorbent material 23 in FIG. 4 includes a monofilament as the base material 13, and further includes a coating layer 4 provided on a surface of the base material 13. The coating layer 4 includes a polymer 41 and the metal particles 3. In an adsorbent material 24 shown in FIG. 5, the base materials 13 are a multifilament including a plurality of monofilaments.

In the example of FIG. 4, the entire surface of the base material (monofilament) 13 is covered with the coating layer 4 and the coating layer 4 has only to be applied to at least a part of the surface of the base material (monofilament) 13.

In the example shown in FIG. 5, the coating layer 4 is present on the surface of the base material (monofilament) 13 and in gaps among the base materials 13. In this example, the surface of the base material (monofilament) 13 is entirely covered with the coating layer 4, and gaps among the base materials (monofilaments) 13 are completely filled with the coating layer 4. However, a part of a surface of the base material (monofilament) 13 or the gap may not be covered with the coating layer 4.

In the case where the base material is a multifilament, when a common tangent between two adjacent monofilaments, among monofilaments present on the outermost part of the yarn bundle constituting the multifilament, is drawn, a region surrounded by outlines of the monofilaments and the common tangents can be distinguished from an outer region thereof as shown by a broken line in FIG. 5. In this region, a region (space) where no monofilament is present is gaps among the monofilaments.

The proportion of the coating layer in the adsorbent material is preferably 30 to 400 parts by mass per 100 parts by mass of base materials.

When the mass proportion of the coating layer is 30 parts by mass or more, an adsorbent material having a large adsorption rate is obtained. When the adsorption rate is large, a substance to be removed can be sufficiently adsorbed and a good removal ratio can be achieved even if raw water is treated under a condition in which a flow rate of the raw water is large relative to a volume of the adsorbent material, that is, a space velocity is high. The mass proportion of the coating layer is more preferably 50 parts by mass or more, and still more preferably 100 parts by mass or more.

On the other hand, when the mass proportion of the coating layer is 400 parts by mass or less, the adsorbent material has flexibility, resulting in easy handling. The mass proportion of the coating layer is more preferably 350 parts by mass or less, and still more preferably 300 parts by mass or less.

The mass proportion of the coating layer to the adsorbent material is calculated by: measuring the mass (W1) of the adsorbent material; then removing the coating layer from the adsorbent material and measuring the mass (W2) of the remaining base material; and performing calculation based on (W2/(W1−W2))×100 (parts by mass).

A method for peeling the coating layer from the adsorbent material is not particularly limited. For example, the adsorbent material is pressed using a nip roll or the like to crush the coating layer, so that the coating layer can be peeled from the adsorbent material.

The removal of the coating layer from the adsorbent material can be confirmed by observing the adsorbent material using a microscope or a scanning electron microscope (SEM).

The polymer in the coating layer is preferably a polymer that has water resistance and does not dissolve in water, or a derivative thereof, and examples thereof include thermoplastic polymers that are miscible with an organic solvent and immiscible with water, such as an ethylene-vinyl alcohol copolymer, polyvinylidene fluoride, and polysulfone, and thermosetting polymers such as an epoxy resin, a phenol resin, and a melamine resin.

The polymer preferably has a hydrophilic group such as a carboxy group, a hydroxy group, and an amino group. When the polymer has a hydrophilic group, permeability of the adsorbent material increases, and the water flow resistance decreases. Accordingly, the treatment can be performed at a high flow rate.

Further, as will be described below, the polymer preferably has functional groups because the metal particles are easily dispersed by bonding to the functional groups.

(A-2-4) Mass Proportion of Metal Particles to Entire Adsorbent Material

The higher the mass proportion of the metal particles is, the better the adsorption performance is. Accordingly, when the entire adsorbent material is set as 100 parts by mass, the mass proportion of the metal particles is preferably 10 parts by mass or more, more preferably 20 parts by mass or more, and still more preferably 30 parts by mass or more. On the other hand, to prevent deformation or breakage by making the adsorbent material to have strength, the proportion of the metal particles is preferably 90 parts by mass or less per 100 parts by mass of adsorbent material, and more preferably 80 parts by mass or less per 100 parts by mass of adsorbent material.

The mass proportion of the metal particles can be measured by the following method. The mass (W1) of the adsorbent material is measured. Next, the adsorbent material is immersed in a good solvent such as a strong alkaline aqueous solution or, if necessary, together with performing heating at 800° C. or higher by means of an electric furnace, so as to dissolve the base material and the polymer in the coating layer. The mass (W3) of the metal particles obtained in this way is measured. The mass proportion of the metal particles relative to the entire adsorbent material is (W3/W1)×100 (parts by mass).

(A-3) Diameter of Fibrous Adsorbent Material

A diameter D of the adsorbent material is 100 μm or more and 600 μm or less. The diameter D is preferably 200 μm or more, and more preferably 300 μm or more. The diameter D is preferably 500 μm or less, and more preferably 450 μm or less. When the diameter D is 100 μm or more, laminated woven and knitted fabric and the winding body can retain voids between the fibers. Accordingly, the water flow resistance decreases. When the diameter D is 600 μm or less, the area of the fibers in contact with the raw water can be increased, and the adsorption rate can be increased.

The diameter D is a diameter of a monofilament when the adsorbent material is a monofilament. When the adsorbent material is a multifilament, the monofilaments constituting the multifilament can be regarded as an adsorbent material, and the diameter of the multifilament is the diameter D in this case.

In the case where the adsorbent material is a multifilament, monofilaments capable of supporting the metal particles and separable from each other (not bonded to each other) are further combined to constitute the multifilament. On the other hand, even if one adsorbent material contains a plurality of base materials, the adsorbent material is a monofilament in a case where a plurality of filaments (which may be either a monofilament or a multifilament) are bonded to each other by a coating layer or the like to form a bundle (example of FIG. 5).

As for a fabric containing an adsorbent material (a fabric obtained by processing fibers that is an adsorbent material or a fabric formed by applying metal particles to a fabric that is a base material), if the fabric is a knitted fabric or a woven fabric, yarns constituting the fabric are observed by a microscope or the like, and the diameter of the yarns is measured, thereby identifying the diameter D of the adsorbent material. In the case where the fabric is a nonwoven fabric, fibers contained in the nonwoven fabric can be observed by a microscope, so that a fiber diameter thereof may be measured as the diameter D of the adsorbent material.

The diameter D of the adsorbent material in the filter is measured by the following method.

In a case where the adsorbent material is contained in the filter by being wound in the form of a yarn, the winding is unwound. In a case where the number of the adsorbent materials contained in the filter is 10 or less, the adsorbent materials are cut and divided into 10 yarns. The adsorbent material is immersed in pure water for 24 hours. Then, ten adsorbent materials are observed with a microscope, and widths thereof are measured at any one location within the view field, respectively. An end part of the adsorbent material is excluded from the object to be measured. An average value of the ten numerical values thus obtained is calculated as the diameter D of the adsorbent material.

In a case where the filter contains an adsorbent material processed into a fabric (knitted fabric, woven fabric, nonwoven fabric), the fabric is immersed in pure water for 24 hours. Then, the immersed fabric is observed with a microscope, and any 10 samples are selected, in the observation field of view, from the yarns contained in the knitted fabric or the woven fabric, or from the fibers contained in the nonwoven fabric, followed by measuring the width thereof. However, in a case where the end of the adsorbent material falls within the view field, the end thereof is excluded from the object to be measured. An average value of the ten numerical values thus obtained is calculated as the diameter D of the adsorbent material.

[(B) Filter]

The filter according to the present embodiment includes at least one of a winding body and a laminated body including the above-described adsorbent material.

(B-1) Adsorbent Material

(B-1-1) Yarn

The adsorbent material may be incorporated into the filter in the form of a yarn. The yarn is in a state of not being processed into a fabric.

(B-1-2) Fabric

The adsorbent material may be incorporated into the filter in a state of being processed into a fabric. Specific examples of the fabric include a woven fabric, a knitted fabric, and a nonwoven fabric. For convenience of description, the adsorbent material in a state of being processed into a fabric may also be referred to as “adsorbent material”, and in that case, the “diameter D” described above refers to the diameter of the yarns contained in the fabric as described above.

When the fabric formed of the adsorbent material fills a column or is wound, a uniform structure can be easily formed. As a result, pressure loss during water flow can be reduced. In addition, the woven fabric is preferred because the woven fabric has higher structural uniformity than the knitted fabric. The pressure loss during water flow is reduced, and thus the treatment at a high flow rate becomes easy.

The kind of the woven fabric is not particularly limited, and examples thereof include three foundation weave such as a plain weave, a twill weave, and a sateen weave, a derivative weave such as a derivative weave and a derivative twill weave, a double weave such as a warp backed weave and a weft backed weave, a warp pile weave such as warp velvet, towel, and velour, and a weft pile weave such as velveteen, weft velvet, velvet, and corduroy. The woven fabric having these woven structures can be woven by a normal method using a normal loom such as a rapier loom and an air jet loom.

An opening (hereinafter, referred to as op) represents a value showing distance between yarns (which may be a monofilament or a multifilament) constituting the woven fabric, and is defined by the following equation.

op (μm)=(25400/n)−D (1)

n (number/inch): number of meshes per 1 inch of woven fabric

D (μm): diameter of the yarns constituting the woven fabric (that is, the diameter of the adsorbent material)

The value obtained by dividing the opening by the diameter of the yarns (op/D) is preferably 0.5 or more, more preferably 0.7 or more, and still more preferably 0.8 or more. In addition, op/D is preferably 3.0 or less, more preferably 2.5 or less, and still more preferably 2.0 or less. When op/D is 0.5 or more, clogging during water flow is less likely to occur, and the water flow resistance is less likely to increase. When op/D is 3.0 or less, the components to be removed in the raw water can be preferably removed without causing short pass of the raw water when the raw water flows through the filter for liquid filtration.

In the measurement of the opening, the method for measuring the diameter D is as described above.

The number n of meshes is measured as follows. A wet woven fabric is observed with a microscope and a line of 1 cm is drawn parallel to a warp yarn. The number n1 of meshes (number/inch) in a direction of the warp yarn is determined from the number of grids on the line. Similarly, a line of 1 cm is drawn parallel to a weft yarn, and the number n2 of meshes (number/inch) in a direction of the weft yarn is determined from the number of grids on the line. The average value of n1 and n2 is defined as n (number/inch).

The kind of the knitted fabric is not particularly limited. The knitted fabric may be a weft knitted fabric or a warp knitted fabric. Preferred examples of weft knitting include plain stitch, rib stitch, interlock stitch, pearl stitch, tuck stitch, float stitch, half cardigan stitch, lace stitch, plating stitch, and the like. Preferred examples of warp knitting include single denbigh stitch, single atlas stitch, double cord stitch, half tricot stitch, fleecy knitting, jacquard knitting, and the like. The knitted fabric can be knitted by a normal method using a normal knitting machine such as a circular knitting machine, a flat knitting machine, a tricot knitting machine, and a raschel knitting machine.

Basis weight of the fabric is preferably 300 g/m² or more, more preferably 350 g/m² or more, and still more preferably 400 g/m² or more. In addition, the basis weight of the fabric is preferably 1500 g/m² or less, more preferably 1000 g/m² or less, and still more preferably 800 g/m² or less. When the basis weight of the fabric is 300 g/m² or more, the components to be removed in the raw water can be suitably removed without causing short pass of the raw water when the fabric is used as the filter for liquid filtration. When the areal density is 1500 g/m² or less, clogging is less likely to occur, and the water flow resistance during water flow can be reduced.

The basis weight is calculated from the mass and the area of the fabric in a dry state.

(B-2) Winding Body

The winding body is an adsorbent material wound around an axis or a nucleus. Here, the terms “axis” and “nucleus” are words referring to a center of the winding (virtual center). That is, the adsorbent material may be wound around another member (core member), but the core member is not essential.

The adsorbent material to be wound may be in the form of a yarn, or may be processed into a fabric (such as a woven fabric, a knitted fabric, a nonwoven fabric).

Various shapes may be employed as an outer shape of the winding body, such as a cylindrical column, a prismatic column such as a triangular prism and a quadrangular prism, a cone, a pyramid such as a triangular pyramid or a quadrangular pyramid, and a sphere or an elliptical sphere.

In addition, the winding body may have a cavity therein. The cavity may be disposed at a central part of the winding.

In the winding body, the adsorbent material may be wound around a core member which is a member different from the adsorbent material. That is, the core member may be disposed at the central part of the winding. Various shapes may be employed as an outer shape of the core member as well as the outer shape of the winding body.

The above-described cavity may be provided in the core member. Examples of the core member having a cavity include hollow members and porous members.

As the material of the core member of the winding body, a synthetic resin is applied as long as it allows water to pass. Specifically, a polyolefin such as polyethylene and polypropylene, or a fluororesin such as PTFE and PFA (tetrafluoroethylene-perfluoroalkyl vinyl ether copolymer) is preferred.

The diameter (outer diameter) of the core member is preferably 5 mm or more, more preferably 20 mm or more, and is preferably 50 mm or less, more preferably 40 mm or less. The length of the core is not particularly limited, and is, for example, 80 mm or more and 500 mm or less.

The end of the wound adsorbent material is preferably fixed to an outer peripheral surface of the wound body by welding, adhesion, or the like.

The filter preferably includes a circular plate or the like provided on an end surface of the winding body (end surface in the height direction when the winding body has a columnar shape).

In addition, the filter may include a casing that houses the winding body.

The filter including the winding body will be described in more detail. In particular, in the following example, feed water (water to be treated) passes through the core member.

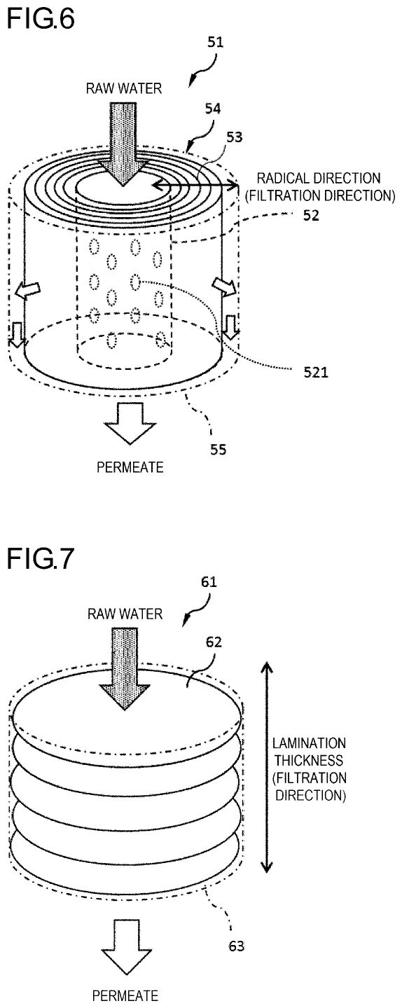

The filter 51 in FIG. 6 includes a core member 52 and an adsorbent material 53. The core member 52 is a hollow member whose upper portion is open and whose bottom is blocked, and a side surface thereof is provided with a plurality of holes 521. The adsorbent material 53 is wound around the core member 52, thereby forming a winding body 54.

The filter 51 further includes a casing 55 that houses the winding body 54. An upper surface of the casing 55 is provided with an opening (not shown), and thus the feed water flows into the core member 52 via the opening of the casing 55 and the opening of the upper portion of the core member 52. A water intake (not shown) of permeate from the holes is provided at a bottom portion of the casing 55, and the permeate flows out of the filter from the water intake.

Although water flow is drawn from an inside of the winding body 54 to an outside thereof in FIG. 6, the water flow may be reversed. That is, water can be supplied to a side surface of the winding body, and the permeate can be collected from the core member. In this case, for example, a casing, whose bottom portion includes an opening through which water can be supplied to space between the winding body 54 and an inner wall of the casing 55, and whose upper surface includes an opening through which permeate is obtained from the opening in the upper portion of the core member 52, may be used as the casing 55 in FIG. 6.

In a case where the adsorbent material in the state of the yarn is wound, deviation δ (m) to be described below is preferably two times or less the diameter of the adsorbent material (diameter of the yarn). Accordingly, a more uniform void structure can be obtained.

(B-3) Laminated Body

Next, a filter including a laminated adsorbent material will be described.

In particular, the term “laminated” refers to a state where the adsorbent material processed into a fabric is superimposed. One filter, that is, one laminated body, may contain only one of a woven fabric, a knitted fabric, and a nonwoven fabric, or may include two or more thereof. The filter 61 shown in FIG. 7 includes a laminated fabric (denoted by reference numeral 62) and a column 63.

The column 63 is a container whose upper portion and lower portion are open. The column 63 accommodates the fabric 62 therein, and receives feed water and discharges permeate. In order to hold the fabric 62, a hole in the lower portion is set to be smaller than a diameter of the column.

(B-4) Common Items for Winding Body and Laminated Body

(B-4-1) Filling Thickness

The common items for the winding body and the laminated body will be described below. Hereinafter, thickness of the winding body and the laminated body in a filtration direction is referred to as “filling thickness”.

The thickness of the winding body and the laminated body in the filtration direction can be optionally determined depending on the amount of raw water to be filtered, and is preferably 5 mm or more, more preferably 10 mm or more, and still more preferably 20 mm or more. When the thickness is 5 mm or more, the winding body and the laminated body can preferably remove the components to be removed in the raw water without causing short pass of the raw water.

(B-4-2) Density of Adsorbent Material in a Wet State

The density ρₐ (g/cm³) of the adsorbent material (yarn) in the wet state is measured as follows.

The winding body is unwound when the filter includes a winding body, a knitted fabric or a woven fabric, and a nonwoven fabric is loosed when the filter includes a nonwoven fabric, thereby obtaining the adsorbent material in the form of a yarn (fiber). A measurement container having a known volume Vt (cm³) is submerged in water, and the adsorbent material in unwound (or loosed) state is placed in the container with no load applied thereto. The adsorbent material is brought into a wet state by being allowed to stand for 24 hours.

On the basis of the volume Vt (cm³) of the container, volume Vw (cm³) of water in the container, and mass Wa (g) of the adsorbent material, the density ρₐ (g/cm³) of the adsorbent material in the wet state is calculated by the following equation.

ρₐ=Wa/(Vt−Vw) (2)

Wa (g): Mass of adsorbent material in a wet state

Vt (cm³): Volume of the measurement container

Vw (cm³): Volume of water present in the measurement container

(Vt−Vw) represents the volume (cm³) of the adsorbent material in the wet state. The volume Vw (cm³) of water is equal to the mass Ww (g) of water, and the mass Ww of water can be calculated by measuring the total mass value Wt (g) of the water and the adsorbent material in the container and subtracting the mass Wa (g) of the adsorbent material from Wt (g).

The mass Wa (g) of the yarn in the wet state is obtained by taking out the adsorbent material from the container and measuring the mass thereof after removing the applied water by suction filtration.

(B-4-3) Porosity of Winding Body and Laminated Body

The porosity of the winding body and the laminated body is 15% or more and 70% or less. The porosity is preferably 30% or more. The porosity is preferably 60% or less, and more preferably 50% or less. When the porosity ε is 15% or more, clogging is less likely to occur during water flow, and the water flow resistance is less likely to increase. When the porosity ε is 70% or less, the raw water passes through the filter without short passing. Accordingly, the components to be removed in the raw water is suitably removed, and a sufficient amount of permeate can be obtained until breakthrough occurs.

The porosity ε (%) of the winding body or the laminated body is calculated by the following equation. The numerical values in Equation (3) are measured for the winding body or the laminated body in a wet state by being immersed in pure water for 24 hours.

ε(%)=(Vf−Wb/ρₐ)/Vf×100 (3)

Vf (cm³): Apparent volume of the winding body or the laminated body

Wb/ρₐ (cm³): Volume of the adsorbent material contained in the winding body or the laminated body

(Vf−Wb/ρ) (cm³): Volume of voids contained in the winding body or the laminated body

Wb (g): Mass of adsorbent material contained in the winding body or the laminated body

ρₐ (g/cm³): Density of the adsorbent material

The apparent volume Vf (cm³) of the winding body or the laminated body is the sum of the volume of the adsorbent material and the volume of the space between the adsorbent materials. This volume can be calculated by measuring an outer shape of the winding body or the laminated body in the wet state. However, when the entire column is filled with the adsorbent material, volume of the column can be regarded as the volume Vf.

With regard to the columnar winding body in which a core member is disposed inside, the volume Vf can be calculated by excluding volume of the core member from volume (R²×π×H) calculated from radius R and height H of the winding body.

The mass Wb (g) is obtained by measuring the mass of the adsorbent material after removing the applied water by suction filtration from the winding body or the laminated body in the wet state.

The method for measuring the density ρₐ (g/cm³) of the adsorbent material is as described above.

(B-4-4) Variation in Area Porosity of Winding Body or Laminated Body

The variation in the area porosity of the winding body or the laminated body is 15% or less, and preferably 10% or less. When the variation in the area porosity is 15% or less, a vortex is less likely to occur during water flow, and the water flow resistance is less likely to increase.

In a case where a fabric formed by an adsorbent material is laminated in the filter, the variation in the area porosity refers to variation in area porosity in a lamination direction (see FIG. 7) of the laminated body. In a case where the filter includes a winding body, the variation in the area porosity refers to variation in area porosity in a radial direction (see FIG. 6) of the winding. In other words, the variation in the area porosity is variation in the area porosity in the filtration direction of the liquid (the direction in which the liquids in FIGS. 6 and 7 pass).

The radial direction of the winding and the lamination thickness direction are collectively referred to as a “thickness direction”.

A method for measuring the variation in the area porosity is as follows. Images of a plurality of slices (cross sections) perpendicular to the thickness direction and parallel to each other are captured by an X-ray CT scan. The resolution (m/pixel) is set as 1/20 of the fiber diameter (yarn diameter) D, and the size of the measurement view field is 512 (pixel)×512 (pixel). A total of 512 images are obtained with spacing identical to the resolution of the 2D image frontward than or rearward than a center of a filling layer in the thickness direction, in which 256 images are frontward than the center and the other 256 images are rearward than the center. That is, a position is shifted by 1 (pixel) over the thickness equal to 512 (pixel), and images of the cross sections are captured. When the thickness is less than 512 (pixel), only an image of a part in which the adsorbent material is present is used for calculation of the variation.

The obtained two-dimensional images of the slices are binarized, and an area proportion (%) of void regions in an entire area of the images is defined as the area porosity. The area porosity is plotted in a measurement direction of the variation, and an approximate straight line is calculated by the least-square method. A value on the approximate straight line of the area porosity at the positions is subtracted from the measurement value of the area porosity, and thus deviation from the approximate straight line of the area porosity at the positions is determined. The variation in the area porosity is defined as a difference between the maximum value and the minimum value of the deviation from the approximate straight line of the area porosity measured in the measurement direction of the variation.

[C. Method for Producing Adsorbent Material]

Next, an example of the method for producing the adsorbent material will be described. The method for producing the adsorbent material includes:
a step (I) of preparing a base material; and
a step (II) of allowing the base material to support the metal particles.

A common spinning method is applied as the step (I). For example, the base material can be spun by extruding a liquid containing a raw material from a nozzle, and melt spinning, wet spinning, dry spinning, or the like can be employed.

The step (II) may be performed on the base material in the state of the yarn, or may be performed after the fiber as the base material is processed into a fabric (that is, a woven fabric, a knitted fabric, or a nonwoven fabric).

Examples of the step (II) include:
preparing any solution of
i) a solution of metal particles,
ii) a solution of a metal salt,
iii) a solution containing a polymer (or a precursor thereof) and metal particles, and
iv) a solution containing a polymer (or a precursor thereof) and a metal salt,
applying the solution to the base material, and performing treatment such as polymerization of the precursor if necessary.

In the above items i) and iii), it is preferable that the metal particles form a nano colloid.

In a case where the solutions in the items i) and ii) are used, the base material preferably has functional groups because the metal particles are easily dispersed by bonding to the functional groups.

In addition, in a case where the solutions in the items iii) and iv) are used, the polymer (including the polymer formed by the precursor) preferably has functional groups because the metal particles are easily dispersed by bonding to the functional groups.

The functional groups referred to herein are not particularly limited, and examples thereof include the functional groups exemplified in (A-2-3-1). The composition of the metal particles forming the nano colloid solution is not particularly limited, and examples thereof include the metals exemplified in the above (A-2-1). The kind of metal salts forming the metal salt solution is not particularly limited, and examples thereof include nitrates, sulfates, chlorides, fluorides, bromides, iodides, acetates, carbonates and chromates of the metal particles exemplified in (A-2-1).

In a case where the solutions in the items ii) and iv) are used, the base material is brought into contact with the metal salt solution or the polymer is brought into contact with the metal salt solution, and, then, if necessary, metal ions of the metal salt may be reduced to form metal particles as a single metal. The reduction method is not particularly limited, and a catalyst, light irradiation, or the like can be further used in combination with regular methods using a chemical reducing agent. A method for measuring a particle diameter of the metal particles will be described below.

Hereinafter, the method of using the solutions in the items iii) and iv), that is, a method for forming the coating layer will be described below particularly.

Examples of the method for forming the coating layer include the following two methods.

(1) The solution containing the precursor of the polymer and metal particles or the metal salt is applied to the base material, and then the base material with the solution applied thereto is heated to generate the polymer from the precursor.

(2) Metal particles or a metal salt is dispersed in a solution, in which a polymer miscible with an organic solvent and immiscible with water is dissolved in an organic solvent. The solution is applied to the base material, and then the base material with the solution applied thereto is immersed in water to solidify the polymer in the solution.

In the above method (1), the solvent contained in the solution is selected according to the precursor or the like. For example, water is used as the solvent. The precursor may be referred to as a “monomer”.

In the above methods (1) and (2), examples of a specific method of applying the solution to the base material include a method of immersing the base material in the solution, and a method of applying the solution to the base material using a coater, a roller, a spray, or the like.

In the above methods (1) and (2), the concentration of the precursor or the polymer in the solution is preferably 50 g/L or more. When the concentration of the precursor or the polymer is 50 g/L or more, the solution can be sufficiently held on the base material. On the other hand, the concentration of the precursor or the polymer is preferably 500 g/L or less. When the concentration is 500 g/L or less, dissolution becomes easy and the viscosity of the solution is not too large. Accordingly, this step can be easily performed.

In the methods (1) and (2), the concentration of the metal particles or the metal salt in the solution is preferably 0.5 times (by mass) or more the concentration of the precursor or the polymer, and more preferably 2 times (by mass) or more the concentration thereof. When the concentration of the metal particles or the metal salt is 2 times (by mass) or more the concentration of the precursor or the polymer, the adsorption capacity can be efficiently imparted to the fibers. On the other hand, the concentration of the metal particles or the metal salt in the solution is preferably 10 times (by mass) or less the concentration of precursor or the polymer, and more preferably 8 times (by mass) or less the concentration thereof. When the concentration of the metal particles or the metal salt is 10 times (by mass) or less the concentration of the precursor or the polymer, the metal particles can be uniformly dispersed in the solution.

In the method (1), the base material is brought into contact with the aqueous solution containing the precursor, and then the excess aqueous solution may be removed before heating the base material. In the method (2), the polymer solution is brought into contact with the base material, and then the excess solution applied to the base material may be removed.

Examples of a device for removing the excess solution include a nozzle (limited to the case where the base material is in the form of yarns), a rubber roller such as a mangle, and an air nozzle. In particular, in a case where a fabric is used as the base material, after draining with a rubber roller such as a mangle, it is possible to remove the solution blocking openings of the fabric as the base material (gaps between the fibers) by further blowing air through an air nozzle or the like.

In the above method (1), examples of the method of heating the base material include a method of heating the base material in a heating device such as an oven and a pin tenter, and a method of blowing hot air using a drier or the like.

In this step, the temperature at which the base material is heated may be set such that the precursor becomes a polymer and can be cured, and the base material is not melted. The temperature is preferably 50° C. or higher, and more preferably 100° C. or higher. When the heating temperature is 50° C. or higher, a curing reaction proceeds. On the other hand, the heating temperature is preferably 250° C. or lower, and more preferably 200° C. or lower. When the heating temperature is 250° C. or lower, the form of the base material can be maintained.

In the above method (2), examples of the organic solvent for dissolving the polymer include dimethyl sulfoxide, N,N-dimethylformamide, N-methyl-2-pyrrolidone, acetone, and the like.

In order to adjust the solidification rate, a small amount of organic solvents may be added to water when the base material with the polymer solution applied thereto is immersed in water. Examples thereof include dimethyl sulfoxide, N,N-dimethylformamide, N-methyl-2-pyrrolidone, acetone, and the like. The temperature of the water is preferably 5° C. or higher, and more preferably 10° C. or higher. When the temperature of the water is 5° C. or higher, solidification of the polymer can be performed in short time. On the other hand, the temperature of the water is preferably 60° C. or lower, and more preferably 40° C. or lower. When the temperature of the water is 60° C. or lower, solidification of the polymer can be effectively performed.

In this step, the time for immersing the base material in the water is preferably adjusted as appropriate according to a pickup rate, and is preferably 5 seconds or more, and more preferably 10 minutes or more. When the immersion time is 5 seconds or more, the solidification of the macromolecules can be sufficiently proceeded. The immersion time is preferably 10 minutes or less, and more preferably 5 minutes or less. When the immersion time is 10 minutes or less, the cost during processing can be reduced.

The number of times of performing the methods (1) and (2) may be one or a plurality of times, and can be optionally selected according to the form of the base material and the pickup rate.

[D. Method for Producing Filter]

(D-1) Winding

Hereinafter, a case where a porous core member is used will be described as an example.

In a case where an adsorbent material processed into the form of a fabric is used, the adsorbent material in the form of a fabric may be wound around the porous core member until the target thickness is reached.

An adsorbent material in the form of a yarn may be wound around the porous core member to for the winding body. A winding angle of the yarn is tilted in a radial direction (direction perpendicular to an axial direction) of the porous core member, and thus the adsorbent material can be wound to spread in the axial direction of the porous core.

When the adsorbent material is wound from a first end to a second end of the porous core member, and is further wound toward the second end (by reversing the winding direction). The adsorbent material is superimposed to form a columnar filling layer by repeating such reciprocating operations continuously.

When deviation width of an adsorbent material wound from the (n+2)th reversion to the (n+3)th reversion relative to an adsorbent material wound from the nth reversion from the start of winding to the (n+1)th reversion is defined as δ (m), δ is preferably two times or less the diameter D, and more preferably 1.5 times or less the diameter D. When δ (m) is 2 times or less the diameter D, the adsorbent material can be laminated while maintaining uniform voids. δ (m) is preferably 0.1 times or more the diameter D, and more preferably 0.5 times or more the diameter D. When δ (m) is 0.1 times or more the diameter D, the overlap between the adsorbent material wound from the nth reversion from the start of winding to the (n+1)th reversion and the adsorbent material wound from the (n+2)th reversion to the (n+3)th reversion can be prevented and short pass of the raw water can be prevented.

The lead angle θ in the winding is expressed by a traverse speed St (m/s), which is a speed at which the porous core member is moved relative to the yarn path in a parallel manner, and a winding speed Sr (m/s) of the yarn, and can be calculated by the following equation.

θ=tan⁻¹(St/Sr) (Equation 4)

A ratio of a rotational speed r (rpm) of the porous core member to traverse frequency ht (cpm) that is the number of inversions per unit time is referred to as a wind ratio W, and can be defined by the following equation.

W=r/ht (Equation 5)

When a fractional part of the wind ratio is denoted by W1, and an outer diameter of the winding body including the porous core member is denoted by R (m), the deviation δ (m) is defined by the following equation.

δ=W1×R×π×sin(θ) (Equation 6)

When the wind ratio W is an integer, that is, when W1=0, the deviation δ (m) is 0 m. When the wind ratio W is set to be constant, the deviation δ (m) is always constant. The deviation is preferably uniform from the inside to the outside of the winding body.

(D-2) Lamination

The lamination method is not particularly limited. For example, the adsorbent material processed into a fabric may be cut into an appropriate size or folded, and may be superimposed until a desired thickness is reached.

[E. Fluid Separation Method]

The filter described above is used for a fluid separation method for removing solutes in a liquid. The fluid separation method may include, for example,
(a) a step of separating a substance contained in a fluid from the fluid by a separation membrane, and
(b) a step of bringing the above fluid into contact with the filter according to the present embodiment. The step (b) may be performed either before or after the step (a).

The separation membrane used in the above step (a) is a membrane by which the substance contained in the fluid can be removed by filtration. Examples of the separation membrane include a reverse osmosis (RO) membrane, a nanofiltration (NF) membrane, a microfiltration (MF) membrane, and an ultrafiltration (UF) membrane.

In the step (b), a fluid that has permeated the separation membrane in the step (a) or a fluid that has not passed through the separation membrane in the step (a) is brought into contact with the filter to adsorb the solute in the fluid to the filter. Accordingly, at least one hazardous substance selected from the group consisting of boron, arsenic, phosphorus, and fluorine in the fluid can be removed.

In the winding body in FIG. 6, raw water flows into the core member 52 from the upper portion of the casing 55, and moves to the winding body 54 through the holes 521 on the side surface of the core member 52. The solutes contained in the raw water are removed while the raw water passes through gaps between the adsorbent materials 53 of the winding body 54. The permeate flows from the side surface of the winding body 54 to space between the winding body 54 and the casing 55, and flows out of the casing 55 from an outlet (not shown) in a lower portion of the casing 55. Thus, in the winding body 54, the radial direction coincides with the filtration direction.

In the filter 61 including the fabric 62 laminated as shown in FIG. 7, the raw water supplied from the upper portion of the column 63 moves while passing over the laminated fabric 62, and the solute contained in the raw water is removed therebetween. The permeate flows out of the outlet in the lower portion of the column 63.

For example, boron in seawater is a component removed by a reverse osmosis membrane, but it is not easy to reduce the boron concentration to a level suitable for drinking water even through a reverse osmosis membrane is used. In order to remove boron, densifying the reverse osmosis membrane to improve the boron removal performance can be also considered. However, densifying the reverse osmosis membrane leads to decrease in water permeability. To obtain the same amount of permeate as in the case of using a non-dense reverse osmosis membrane, facility becomes larger and treatment cost is increased. In contrast, when the filter according to the present invention is used, the concentration of boron of finally obtained water can be reduced without densifying the reverse osmosis membrane (that is, without reducing the water permeability performance). Here, boron is used as an example, the same is applied to arsenic, phosphorus, and fluorine.

The term “raw water” refers to water to be treated, and is a word including, for example, seawater, brine, groundwater, wastewater, or the like. The term “raw water” is not limited to a specific embodiment.

In addition, the raw water may be allowed to permeate a pre-filter before permeating a separation membrane element. The pre-filter mainly removes fine particles or the like in the raw water and reduces load on the separation membrane.

### EXAMPLE

Hereinafter, the present invention will be described in more detail by way of Examples, but the present invention is not limited to these Examples.

(1) Mass Proportion (Parts by Mass) of Metal Particles to Entire Adsorbent Material

The mass (W1) of the adsorbent material was measured. Next, the adsorbent material was dissolved in a strong alkaline aqueous solution to take out the metal particles. The mass (W3) of the obtained metal particles was measured. The mass proportion of the metal particles to the entire adsorbent material was calculated by (W3/W1)×100 (parts by mass).

(2) Mass Proportion (Parts by Mass) of Coating Layer to Mass of Base Material

The mass (W1) of the adsorbent material was measured. Next, the adsorbent material was pressed with a nip roll to crush the coating layer, thereby peeling the coating layer, and the mass (W2) of the coating layer was measured. The mass proportion of the coating layer to the mass of the base material was calculated by (W2/(W1−W2))×100 (parts by mass). The removal of the coating layer was confirmed by SEM observation.

(3) Diameter D of Adsorbent Material and Opening (Op)

The adsorbent material was immersed in pure water for 24 hours, and then was observed with a microscope to measure diameters of 10 fibers, and the average value of the diameters was determined as the diameter D of the fibrous adsorbent material. In a case where the adsorbent material was a multifilament, a diameter of the fiber bundle was measured.

The opening was determined based on the above equation (1). The method for measuring the diameter D is as described above. In the method of measuring n, a wet woven fabric was observed with a microscope, and a line of 1 cm was drawn parallel to a warp yarn. The number n1 of meshes in the warp yarn direction was determined from the number of grids on the line. Similarly, a line of 1 cm was drawn parallel to a weft yarn, and the number n2 of meshes in the weft yarn direction was determined from the number of grids on the line. The average value of n1 and n2 was determined as n (number/inch).

(4) Porosity

The density of the adsorbent material was measured based on the above equation (2).

A measurement container having a known volume Vt (cm³) is submerged in water, and the adsorbent material is placed in the container with no load applied thereto. The adsorbent material is brought into a wet state by being allowed to stand for 24 hours. On the basis of the volume Vt (cm³) of the container, volume Vw (cm³) of water in the container, and mass Wa (g) of the adsorbent material, the density ρₐ (g/cm³) of the adsorbent material in the wet state is calculated by the equation (2).

In addition, the porosity ε (%) of the winding body or the laminated body was determined based on the above equation (3). Regarding the winding body, the apparent volume Vf of the winding body or the laminated body was calculated from the outer shape thereof, and regarding the laminated body filling inside the column, the volume of the column was regarded as the volume Vf.

(5) Particle Diameter of Metal Particles (Nm)

The surface of the adsorbent material was observed with a scanning electron microscope at any magnification of 1 to 100,000 times to capture an image thereof, and a transparent film or sheet was superimposed on the obtained photograph. A part corresponding to the metal particles was filled with oil-based ink or the like. Next, an area of the region corresponding to the metal particles was determined using an image analyzer. This measurement was performed on any 30 metal particles, and an average area S (area per metal particle) was calculated by number averaging. Using this average area, the particle diameter of the metal particles was calculated from 2×((S/π)^{0.5}) assuming that the metal particles on the photograph were perfect circles.

(6) Removal Rate of Boron

Raw water was passed through the filter so that the space time (SV) value was 500 (hr⁻¹). An aqueous solution of boric acid of 0.185 mmol/L was used as raw water to determine the removal ratio of boron.

After the raw water permeated the column at 10 bed vol., 10 mL of the raw water was sampled, and the concentration of boron in the permeate was measured by ICP-AES (Inductively Coupled Plasma-Atomic Emission Spectrometry) to calculate the removal ratio of boron. The bed vol. is a value obtained by dividing the volume of the permeate by the volume of the filling layers.

The filling layer means a part in the column, which is filled with the adsorbent material. In this measurement method, since the entire column is filled with the adsorbent material, the volume of the column coincides with the volume of the filling layer.

(7) Water Flow Resistance

Pure water was passed through the filter, and pressure loss, which is a difference between pressure at the time of flowing in the filter and pressure at the time of flowing out of the filter, was measured. A value A (Pa/m) obtained by dividing the pressure loss by the thickness of the filling layer was measured by changing the permeate flow rate (m/s). Next, a value B obtained by dividing the pressure loss when the pure water was passed through without filling the device with a sample by the thickness of the filling layer was measured by changing the permeation flow rate. A relationship between a flow rate and a value obtained by subtracting the value B from the value A and dividing pressure loss of the sample by the thickness of the filling layer was plotted, and was confirmed to be a direct proportion relationship. From a slope of this straight line, the water flow resistance (Pa s/m²) of the sample in the filling layer was determined.

### Example 1

A polyethylene terephthalate fiber having a degree of irregularity of 1.8 and a fiber diameter of 200 μm, which was formed of 72 filaments, was used to knit a knitted fabric by a 22-gauge circular knitting machine. The knitted fabric was refined, dried, and was subjected to intermediate setting according to a common method. Next, two surfaces of this knitted fabric were subjected to corona discharge treatment at a surface treatment intensity of 30 W min/m² in nitrogen atmosphere. The obtained knitted fabric was immersed in a nano colloid solution of cerium oxide (solvent: water, concentration: 5 mass %) at room temperature for 1 day.

Then, water washing for removing excess nano colloid solution of cerium oxide was performed, and then an adsorbent material in which cerium oxide was bonded to functional groups of the polyethylene terephthalate fiber was obtained. The obtained adsorbent material was laminated in a column having a diameter of 40 mm and a thickness of 20 mm up to the upper end of the column while not applying a load in water, and the column was sealed.

### Example 2

A polyethylene terephthalate fiber having a degree of irregularity of 1.8 and a fiber diameter of 200 μm, which was formed of 72 filaments, was used to produce a woven fabric with the mesh number of warp yarns and weft yarns of 40 (number/inch) by a plain weaving machine. Next, two surfaces of this woven fabric were subjected to corona discharge treatment at a surface treatment intensity of 30 W min/m² in nitrogen atmosphere. The obtained woven fabric was immersed in a nano colloid solution of cerium oxide (solvent: water, concentration: 5 mass %) at room temperature for 1 day.

Then, water washing for removing excess nano colloid solution of cerium oxide was performed, and then an adsorbent material in which cerium oxide was bonded to functional groups of the polyethylene terephthalate fiber was obtained. The obtained adsorbent material was laminated in a column having a diameter of 40 mm and a thickness of 20 mm up to the upper end of the column while not applying a load in water, and the column was sealed.

### Example 3

A polyethylene terephthalate fiber having a degree of irregularity of 1.8 and a fiber diameter of 200 μm, which is formed of 72 filaments, was used to produce a woven fabric with the mesh number of warp yarns and weft yarns of 40 (number/inch) by a plain weaving machine. An ethylene vinyl alcohol copolymer (manufactured by Nippon Synthetic Chem Industry Co., Ltd., Soarnol E type) was dissolved in dimethyl sulfoxide at a concentration of 12 mass %, and fine particles of cerium hydrous oxide (average particle diameter 300 nm) were added to the solution at an amount that is 6 times (by mass) the amount of the copolymers, followed by sufficient stirring and dispersing, so that a solution of 1 L was prepared. About 10 g of the woven fabric was immersed in the solution. Next, this woven fabric was drained with a mangle and air was blown thereto with an air nozzle. Then, the woven fabric was immersed in water. When immersion of the woven fabric to the solution, drainage, and immersion of the woven fabric to the water are defined as one cycle, two cycles were carried out, thereby obtaining an adsorbent material in which a layer of polymers containing cerium oxide is provide on a surface of the polyethylene terephthalate fiber.

The obtained adsorbent material was laminated in a column having a diameter of 40 mm and a thickness of 20 mm up to the upper end of the column while not applying a load in water, and the column was sealed.

### Example 4

A polyethylene terephthalate fiber having a degree of irregularity of 1.8 and a fiber diameter of 200 μm, which was formed of 72 filaments, was used to produce a woven fabric with the mesh number of warp yarns and weft yarns of 40 (number/inch) by a plain weaving machine. To an aqueous solution contains polyacrylic acid 25,000 (manufactured by Wako Pure Chemical Industries, Ltd) of 5 mass % and polyglycerol polyglycidyl ether (manufactured by Nagase ChemteX Corporation, EX-512) of 5 mass % as a precursor of the polymer, fine particles of cerium hydrous oxide (average particle diameter 300 nm) was added in an amount that is 5 times (by mass) the amount of precursor, followed by sufficient stirring and dispersing, so that a solution of 1 L was prepared. About 10 g of the woven fabric was immersed in the solution. Next, this woven fabric was drained with a mangle, and air was blown thereto with an air nozzle. Then, the woven fabric was heated at 130° C. for 3 minutes. The obtained woven fabric was washed with running water and dried by being heated again at 130° C. for 3 minutes. When immersion of the woven fabric to the solution, drainage, heating, washing, and drying are defined as one cycle, three cycles were carried out. The obtained adsorbent material in the form of a woven fabric was immersed in a sodium carbonate aqueous solution of 1 mol/L for 1 hour, thereby converting carboxy groups to sodium type. Further, the immersed adsorbent material was washed with pure water until the pH of the washing water is 8 or less, and an adsorbent material in which a layer of polymers containing cerium oxide is provided on the surface of the polyethylene terephthalate fibers was obtained.

The obtained adsorbent material was laminated in a column having a diameter of 40 mm and a thickness of 20 mm up to the upper end of the column while not applying a load in water, and the column was sealed.

### Example 5

An adsorbent material was obtained in the same manner as in Example 4, except that the amount of polyacrylic acid was 15 mass %, and the amount of the fine particles of cerium hydrous oxide was 3 times (by mass) the amount of the precursor.

The obtained adsorbent material was laminated in a column having a diameter of 40 mm and a thickness of 20 mm to up to the upper end of the column while not applying a load in water, and the column was sealed.

### Example 6

An adsorbent material was obtained in the same manner as in Example 5, except that the amount of the fine particles of cerium hydrous oxide was 2 times (by mass) the amount of the precursor.

The obtained adsorbent material was laminated in a column having a diameter of 40 mm and a thickness of 20 mm up to the upper end of the column while not applying a load in water, and the column was sealed.

### Example 7

An ethylene vinyl alcohol copolymer (manufactured by Nippon Synthetic Chem Industry Co., Ltd., Soarnol E type) was dissolved in dimethyl sulfoxide at a concentration of 12 mass %, and fine particles of cerium hydrous oxide (average particle diameter 300 nm) were added to the solution at an amount that is 6 times (by mass) the amount of the copolymers, followed by sufficient stirring and dispersing, so that a solution of 1 L was prepared. A polyethylene terephthalate fiber having a degree of irregularity of 1.8 and a fiber diameter of 200 μm, which is formed of 72 filaments, was immersed in the solution. Next, the polyethylene terephthalate fiber was drained with a nozzle having a diameter of 400 μm, and then was immersed in water. When immersion of the woven fabric to the solution, drainage, and immersion of the woven fabric to the water are defined as one cycle, two cycles were carried out, thereby obtaining an adsorbent material in which a layer of polymers containing cerium oxide is provide on a surface of the polyethylene terephthalate fiber. Next, the fibrous adsorbent material was wound around a porous core member having an outer diameter of 42 mm under conditions of a traverse width of 110 mm, a traverse speed of 8 mm/s, and a spindle rotational speed of 105 rpm, thereby preparing a winding body having an outer diameter of 62 mm and a height of 110 mm.

### Comparative Example 1

An ethylene vinyl alcohol copolymer was dissolved in dimethyl sulfoxide at a concentration of 12 mass %, and fine particles of cerium hydrous oxide (average particle diameter 4 μm) were added to the solution at an amount that was 6 times (by mass) the amount of the copolymers, followed by sufficient stirring and dispersing, so that a dispersion liquid was prepared. Next, this dispersion liquid was discharged from a nozzle in a spray form, immersed in water and solidified to obtain a porous formed body having a spherical structure. The obtained adsorbent material was laminated in a column having a diameter of 40 mm and a thickness of 20 mm up to the upper end of the column while not applying a load in water, and the column was sealed.

### Comparative Example 2

An adsorbent material was obtained in the same manner as in Example 3 except that the step of blowing air by the air nozzle was not performed. The obtained adsorbent material was laminated in a column having a diameter of 40 mm and a thickness of 20 mm up to the upper end of the column while not applying a load in water, and the column was sealed.

### Comparative Example 3

An ethylene vinyl alcohol copolymer (manufactured by Nippon Synthetic Chem Industry Co., Ltd., Soarnol E type) was dissolved in dimethyl sulfoxide at a concentration of 12 mass %, and fine particles of cerium hydrous oxide (average particle diameter 300 nm) were added to the solution at an amount that was 6 times (by mass) the amount of the copolymers, followed by sufficient stirring and dispersing, so that a solution of 1 L was prepared. A polyethylene terephthalate fiber having a degree of irregularity of 1.8 and a fiber diameter of 200 μm, which was formed of 72 filaments, was immersed in the solution. Next, the polyethylene terephthalate fiber was drained with a nozzle having a diameter of 430 μm, and then was immersed in water. When immersion of the woven fabric to the solution, drainage, and immersion of the woven fabric to the water are defined as one cycle, two cycles were carried out, thereby obtaining an adsorbent material in which a layer of polymers containing cerium oxide was provide on a surface of the polyethylene terephthalate fiber. Next, the fibrous adsorbent material was wound around a porous core member having an outer diameter of 42 mm and a length of 110 mm to form the same shape as in Example 6 under conditions of a traverse speed of 8 mm/s and a spindle rotational speed of 104 rpm.

### Comparative Example 4

An adsorbent material was obtained in the same manner as in Example 3 except that the number of meshes of the woven fabric formed of the fibers as the base material was 75 (number/inch). The obtained adsorbent material was laminated in a column having a diameter of 40 mm and a thickness of 20 mm up to the upper end of the column while not applying a load in water, and the column was sealed.

### Comparative Example 5

An adsorbent material was obtained in the same manner as in Example 3 except that the number of meshes of the woven fabric formed of the fibers as the base material was 20 (number/inch). The obtained adsorbent material was laminated in a column having a diameter of 40 mm and a thickness of 20 mm up to the upper end of the column while not applying a load in water, and the column was sealed.

### Comparative Example 6

An adsorbent material was obtained in the same manner as in Example 3 except that the base material was a polyethylene terephthalate fiber having a degree of irregularity of 1.8 and a fiber diameter of 550 μm, which was formed of 144 filaments, and the woven fabric was a plain-weave woven fabric whose number of meshes was 15 (number/inch). The obtained adsorbent material was laminated in a column having a diameter of 40 mm and a thickness of 20 mm up to the upper end of the column while not applying a load in water, and the column was sealed.

### Comparative Example 7

An adsorbent material was obtained in the same manner as in Example 3 except that the base material was a polyethylene terephthalate fiber having a degree of irregularity of 1.8 and a fiber diameter of 60 μm, and the woven fabric was a plain-weave woven fabric whose number of meshes was 150 (number/inch). The obtained adsorbent material was laminated in a column having a diameter of 40 mm and a thickness of 20 mm up to the upper end of the column while not applying a load in water, and the column was sealed.

The performances of the filters prepared in Examples 1 to 7 and Comparative Examples 1 to 7 are shown in Tables 1 and 2.

TABLE 1

| | | | Example 1 | Example 2 | Example 3 | Example 4 | Example 5 | Example 6 | Example 7 |
|---|---|---|---|---|---|---|---|---|---|
| | | | Form | | | | | | |
| | | | Knitted | Woven | Woven | Woven | Woven | Woven | Winding |
| | | | fabric | fabric | fabric | fabric | fabric | fabric | body |
| Metal | Particle | nm | 43 | 45 | 423 | 435 | 489 | 466 | 405 |
| particle | diameter | | | | | | | | |
| | Mass | Part(s) | 25 | 28 | 39 | 40 | 56 | 44 | 46 |
| | | by mass | | | | | | | |

| | | | | | | | | |
|---|---|---|---|---|---|---|---|---|
| Mass of polymer | Part(s) | — | — | 82 | 103 | 285 | 200 | 93 |
| containing metal | by mass | | | | | | | |
| particles | | | | | | | | |
| Fiber diameter | μm | 231 | 236 | 270 | 285 | 392 | 346 | 278 |
| Opening op | μm | — | 399 | 365 | 350 | 243 | 289 | — |
| D/op | — | — | 0.59 | 0.74 | 0.81 | 1.62 | 1.20 | — |
| Porosity | % | 68.3 | 62.8 | 57.5 | 55.1 | 38.3 | 45.5 | 37.6 |
| Variation in area | % | 12.9 | 3.8 | 4.9 | 5.1 | 4.0 | 4.3 | 10.2 |
| porosity | | | | | | | | |
| Removal rate | % | 98.1 | 99.0 | 95.4 | 97.8 | 99.5 | 97.6 | 95.9 |
| Water flow | ×10⁶ | 0.5 | 0.7 | 0.9 | 1.2 | 3.4 | 1.5 | 8.1 |
| resistance | Pa · s/m² | | | | | | | |

TABLE 2

| | | | Comparative | Comparative | Comparative | Comparative | Comparative | Comparative | Comparative |
|---|---|---|---|---|---|---|---|---|---|
| | | | example 1 | example 2 | example 3 | example 4 | example 5 | example 6 | example 7 |
| | | | Form | | | | | | |
| | | | | Woven | Winding | Woven | Woven | Woven | Woven |
| | | | Particle | fabric | body | fabric | fabric | fabric | fabric |
| Metal | Particle | nm | 4,865 | 440 | 416 | 422 | 415 | 423 | 419 |
| particle | diameter | | | | | | | | |
| | Mass | Part(s) | 64 | 43 | 42 | 43 | 38 | 45 | 41 |
| | | by mass | | | | | | | |

| | | | | | | | | |
|---|---|---|---|---|---|---|---|---|
| Mass of polymer | Part(s) | — | 92 | 96 | 90 | 85 | 98 | 93 |
| containing metal | by mass | | | | | | | |
| particles | | | | | | | | |
| Fiber diameter | μm | — | 277 | 280 | 276 | 272 | 774 | 83 |
| Opening op | μm | — | 358 | — | 63 | 998 | 919 | 86 |
| D/op | — | — | 0.77 | — | 4.38 | 0.27 | 0.84 | 0.97 |
| Porosity | % | 63.8 | 55.1 | 38.9 | 14.1 | 75.9 | 53.5 | 50.9 |
| Variation in area | % | — | 19.3 | 20.6 | 6.9 | 3.1 | 4.6 | 5.9 |
| porosity | | | | | | | | |
| Removal rate | % | 55.4 | 97.8 | 96.9 | 99.1 | 63.9 | 42.9 | 98.8 |
| Water flow | ×10⁶ | 4.8 | 19.6 | 22.3 | 98.3 | 0.1 | 0.1 | 39.9 |
| resistance | Pa · s/m² | | | | | | | |

Although the present invention has been described in detail with reference to specific embodiments, it will be apparent to those skilled in the art that various changes and modifications can be made without departing from the spirit and scope of the present invention. This application is based on Japanese Patent Application (Japanese Patent Application No. 2017-189898) filed on Sep. 29, 2017, the contents of which are incorporated herein by reference.

### INDUSTRIAL APPLICABILITY

The adsorbent material according to the present invention is preferably used for removing hazardous substances contained in a fluid such as water or gas.

### REFERENCE SIGN LIST

1 Monofilament
3 Metal particle
4 Coating layer
11 to 13 Base material
21 to 24 Adsorbent material
41 Polymer
51 Filter
52 Core member
53 Adsorbent material
54 Winding body
55 Casing
61 Filter
62 Fabric
63 Column
521 Hole

1.-6. (canceled)

7. A filter comprising at least one of a winding body containing a fibrous adsorbent material or a laminated body containing the fibrous adsorbent material,
wherein
(a) the fibrous adsorbent material is capable of adsorbing a component dissolved in a liquid,
(b) the fibrous adsorbent material includes a base material and metal particles supported by the base material,
(c) the fibrous adsorbent material has a diameter D of 100 μm or more and 600 μm or less,
(d) the metal particle has a particle diameter of 1 nm or more and 1000 nm or less,
(e) the metal particles are supported by the base material in at least one form selected from the following (1) to (3):
(1) the metal particles are bonded to the base material via functional groups;
(2) the base material has holes, and the metal particles are supported in the holes; and
(3) a coating layer containing the metal particles and a polymer is provided on a surface of the base material,
(f) the winding body and the laminated body have porosity of 15% or more and 70% or less, and
(g) variation in area porosity of the winding body in a radial direction of a winding and variation in the area porosity of the laminated body in a lamination direction are 15% or less.

8. The filter according to claim 7, wherein
(h) in the case where the filter comprises the laminated body of a woven fabric,
0.5≤op/D≤3.0 (I)
(op: an opening of the woven fabric; D (μm): diameter of yarns constituting the woven fabric), is satisfied, and
(i) in the case where the filter comprises the winding body, deviation width δ (m) of a wound fibrous adsorbent material is 0.1 times or more and 2 times or less of the diameter D.

9. The filter according to claim 7, wherein the base material is a monofilament or a multifilament comprising a plurality of monofilaments.

10. The filter according to claim 7, wherein the metal particles are particles containing at least one selected from the group consisting of silver, copper, iron, titanium, zirconium, and cerium.

11. The filter according to claim 7, wherein the fibrous adsorbent material contains the metal particles in a proportion of 10 parts by mass or more per 100 parts by mass of the fibrous adsorbent materials.

12. The filter according to claim 7,
wherein the metal particles are supported by the base material in the form of (3), and
the fibrous adsorbent material includes 30 to 400 parts by mass of the coating layers per 100 parts by mass of the base materials.

13. A fluid separation method comprising:
(a) a step of separating a substance contained in a fluid from the fluid by a separation membrane, and
(b) a step of bringing the fluid into contact with the filter according to claim 7,
wherein the step (b) is performed before or after the step (a).
